(19) United States
(12) Patent Application Publication
(10) Pub. No.: US 2010/0217844 A1
(43) Pub. Date: Aug. 26, 2010

(54) DEVICE CONNECTABLE TO NETWORK AND METHOD

(75) Inventor: Junichi NINOMIYA, Kawasaki (JP)

Correspondence Address: Fujitsu Patent Center;Fujitsu Management Services of America, Inc., 2318 Mill Road, Suite 1010, Alexandria, VA, 22314, US

(73) Assignee: FUJITSU LIMITED, Kawasaki-shi (JP)

(21) Appl. No.: 12/705,664

(22) Filed: Feb. 15, 2010

(30) Foreign Application Priority Data
Feb. 25, 2009 (JP) 2009-042497

(51) Int. Cl. G06F 15/177

(52) U.S. Cl. 709/221

(57) ABSTRACT

A device that is connectable to a network includes a storage unit that stores first setting information related to a accessible website in association with an identifier of the website, and a determination unit that determines whether or not the website is accessible by comparing the first setting information to second setting information that is set in the device before access to the website is performed while the device is connected to the network.

### CROSS-REFERENCE TO RELATED APPLICATIONS

This application is based upon and claims the benefit of priority of the prior Japanese Patent Application No. 2009-042497, filed on Feb. 25, 2009, the entire contents of which are incorporated herein by reference.

### FIELD

The present invention relates to a device that is connectable to, for example, a network and a method for determining accessibility to, for example, a website.

### BACKGROUND

To access a website connected to the Internet, a user uses an address displayed in a bookmark, a list box, or the like stored in a user device. There are various known techniques for managing the bookmark as follows.

There is a known bookmark management function for storing a Uniform Resource Locator (URL) of a bookmark and access information of the URL (for example, see Japanese Laid-Open Patent Publication No. 2005-339356). The above-described access information may include, for example, the number of reference, the last reference date and time, and the like.

For example, there is a known device that performs ping with respect to each website attached with a bookmark to obtain information about a response and a congestion state (for example, see Japanese Laid-Open Patent Publication No. 2003-50824).

There is a known method for grasping an update state of each web page by comparing the last update time and the last access time of the web page obtained by accessing the web page successively (for example, see Japanese Laid-Open Patent Publication No. 11-296428).

When the above-described technique is used, the fact that the access is not successful is not known until a user actually accesses the website. This takes time for the user to confirm the accessibility.

The above-described technique does not assume that the user does not change an access network. When a user device is connected to a website through a different network, the user device may not be able to access the website. In this case, the above-described problem occurs.

Even when the user device is successfully connected to the network, the user device may not be able to access the website depending on set security settings. In this case, the above-described problem also occurs.

### SUMMARY

According to an aspect of the invention, a device that is connectable to a network includes a storage unit that stores first setting information related to a accessible website in association with an identifier of the website, and a determination unit that determines whether or not the website is accessible by comparing the first setting information to second setting information that is set in the device before access to the website is performed while the device is connected to the network.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a diagram illustrating a configuration of a mobile device,

FIG. 2 is a diagram illustrating a configuration of a network,

FIG. 3 is an explanation diagram of a device according to an embodiment,

FIG. 4 is an example of a data item to be stored in a data storage unit according to an embodiment,

FIG. 5 is an example for determining accessibility to an URL registered in a bookmark, a list box, or the like according to an embodiment,

FIG. 6 is a flow diagram of processing for collecting information when access to a website is successful according to an embodiment,

FIG. 7 is a flow diagram of a process for displaying a bookmark, a list box, or the like according to an embodiment,

FIG. 8 is a flow diagram of a process for accessing an URL registered in a bookmark, a list box, or the like according to an embodiment,

FIG. 9 is a display example of accessibility to a bookmark according to an embodiment,

FIG. 10 is another display example of accessibility to a bookmark according to an embodiment, and

FIG. 11 is a display example of accessibility to a URL registered in a list box or the like according to an embodiment.

### DESCRIPTION OF THE EMBODIMENTS

Description will be made below of an embodiment with reference to accompanying diagrams.

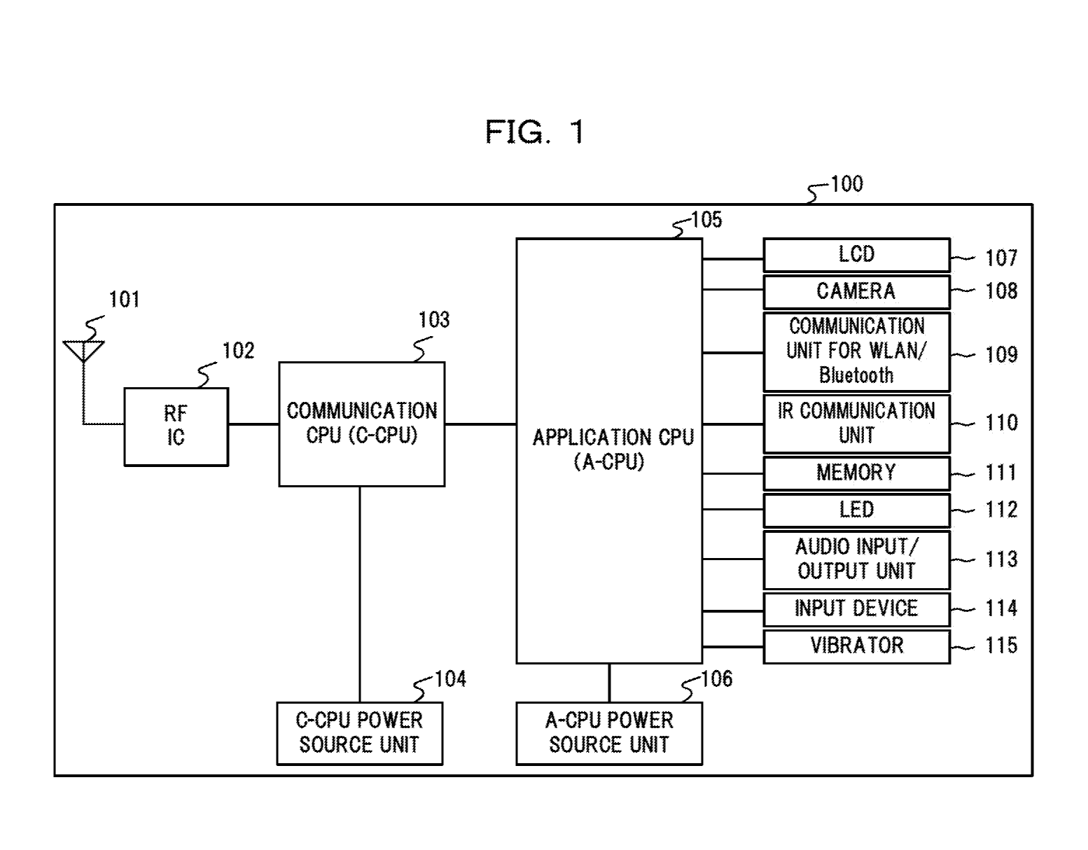

FIG. 1 is a diagram illustrating a configuration of a mobile type of device 100. The device 100 may be, for example, a mobile phone terminal, a notebook personal computer (PC), a personal digital assistant (PDA), and the like.

The device 100 includes an antenna 101, an RF IC 102, a communication CPU (C-CPU) 103, a C-CPU power source unit 104, an application CPU (A-CPU) 105, and an A-CPU power source unit 106. The RF IC may be called a frequency conversion IC, for example. The communication CPU may be called a C-CPU, for example. The Application CPU may be called an A-CPU, for example. Furthermore, the device 100 may include a display device 107 such as a liquid crystal display (LCD), a camera 108, a communication unit 109 for wireless local area network (WLAN)/Bluetooth and the like, an infrared ray (IR) communication unit 110, a light-emitting diode (LED) 112, an audio input/output unit 113, an input device 114 such as a keypad, and a vibrator 115.

The device 100 may further include a memory 111. The memory 111 may be a memory that is built in the communication CPU 103 or the A-CPU 105, another memory that is built in the device 100, or a removable memory.

The device 100 does not have to include all of the above-described components and may include an additional component.

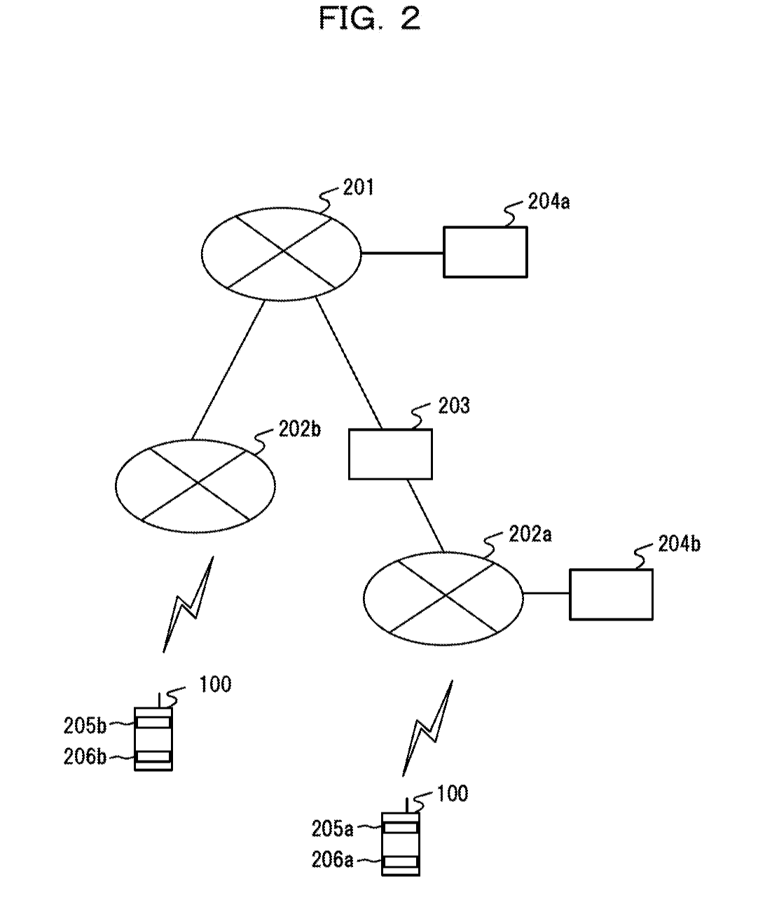

FIG. 2 is a diagram illustrating a configuration of a network. FIG. 2 is a diagram illustrating the device 100 as illustrated in FIG. 1, an Internet 201, wireless local area networks (WLANs) 202a and 202b, a proxy 203, and websites 204a and 204b. The WLANs 202a and 202b may be, for example, a WLAN provided to the public by a communications company, a WLAN provided by a company for which a user of the device 100 works to employees in the site of the company itself, or a WLAN provided in a house of the user of the device 100. Alternatively, one or both of the WLAN 202a or the WLAN 202b may be replaced by another wireless or wired network.

The device 100 is connected to the WLAN 202a and accesses the website 204a through the proxy 203 and the Internet 201. When the device 100 is connected to the WLAN 202a, network information 205a is allocated to the device 100 and is stored in the memory 111 of the device 100.

The network information 205a includes an Internet Protocol (IP) address, a subnet mask, an address of a default gateway, and the like. For example, the IP address may be dynamically allocated to the device 100 by a Dynamic Host Configuration Protocol (DHCP) server of the WLAN 202a. Alternatively, the network information 205a may be set in the device 100 by the user.

The user sets browser setting information 206a, that is, performs proxy setting to determine whether or not to use a proxy, and performs security level setting of a browser. Alternatively, the browser setting information 206a may be set in advance by the browser.

The user of the device 100 may register the address of the website 204a as a bookmark by using, for example, a menu of the browser. When the website 204a is registered in the bookmark, the network information 205a and the browser setting information 206a are stored in the memory 111 of the device 100.

Instead of the bookmark, a URL displayed in a list box or the like of an address bar of the browser may be used. When the user accesses the website 204a, the URL of the website 204a is recorded in the memory 111 and is displayed in the address bar, the list box, or the like. In this case, when the URL of the website 204a is recorded in the memory 111, the network information 205a and the browser setting information 206a are also stored in the memory 111 of the device 100.

The user may move to a service area of the WLAN 202b with the device 100 from the service area of the WLAN 202a. The network information 205b is allocated to the device 100 connected to the WLAN 202b. The network information 205b is stored in the memory 111 of the device 100.

The network information 205b includes an IP address, a subnet mask, an address of a default gateway, and the like. For example, the IP address may be dynamically allocated to the device 100 by the DHCP server of the WLAN 202b. Alternatively, the network information 205b may be set in the device 100 by the user. The user uses the device 100 to again access the website 204a through the WLAN 202b and the Internet 201 by using the registered bookmark, the list box, or the like.

Before the device 100 again accesses the website 204a through the WLAN 202b, the browser setting information 206a may be changed into the browser setting information 206b by the user or the browser.

As described above, when a website is registered in the bookmark or a URL is registered in the list box or the like, that is, when the access to the website 204a is successful, and when the user attempts to again access the website 204a by using the bookmark, the list box, or the like, the network information 205a and 205b may be different. The above-described difference may occur because the access network to which the device 100 is connected is changed. In spite of whether or not the access network is changed, the difference may also occur because the user or the browser changes the network information 205 and the browser setting information 206.

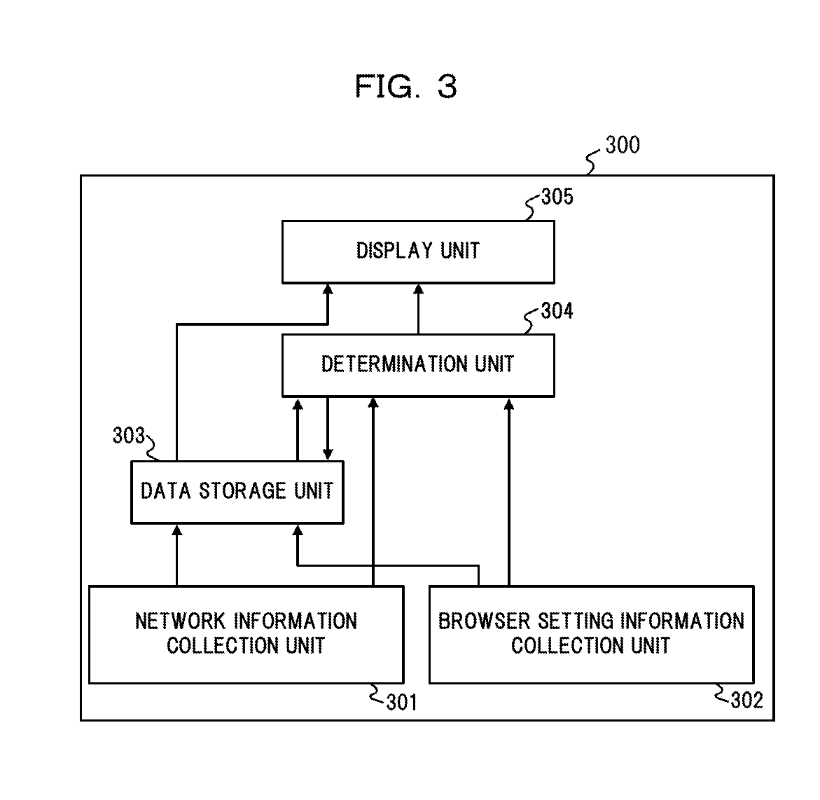

FIG. 3 is an explanation diagram of the device according to an embodiment. A device 300 may be, for example, the device 100 as illustrated in FIG. 1. The device 300 includes a network information collection unit 301, a browser setting information collection unit 302, a data storage unit 303, a determination unit 304, and a display unit 305.

The network information collection unit 301, the browser setting information collection unit 302, and the determination unit 304 illustrated in FIG. 3 are included in the A-CPU 105 illustrated in FIG. 1. The data storage unit 303 illustrated in FIG. 3 is included in the memory 111 illustrated in FIG. 1. The display unit 305 illustrated in FIG. 3 corresponds to, for example, the LCD 107 illustrated in FIG. 1.

The network information collection unit 301 collects the network information 205a and 205b from the memory 111. The network information collection unit 301 may collect the network information 205a when the access to the website 204a is successful. Next, the network information collection unit 301 stores the network information 205a in the data storage unit 303 in association with an identifier such as the URL of the website 204a.

Alternatively, the network information collection unit 301 may collect and store the network information 205a in the data storage unit 303 when the website 204a is registered as a bookmark in the browser, when the URL is registered in the list box or the like, or when the access to the website 204a is successful.

The network information collection unit 301 may collect the network information 205b while the device 100 is being connected to the WLAN 202b. At this time, the device 100 has not yet accessed the website 204a through the WLAN 202b. Next, the network information collection unit 301 transmits the network information 205b to the determination unit 304.

The network information collection unit 301 may collect and transmit the network information 205b to the determination unit 304 each time the device 100 is connected to the WLAN 202b. Alternatively, the network information collection unit 301 may collect and transmit the network information 205b to the determination unit 304 each time the browser is started, each time the bookmark is displayed, or each time the list box or the like is displayed.

The browser setting information collection unit 302 collects the browser setting information 206a and 206b from the memory 111. The browser setting information collection unit 302 may collect the browser setting information 206a when the access to the website 204a is successful. Next, the browser setting information collection unit 302 stores the browser setting information 206a in the data storage unit 303 in association with an identifier such as the URL of the website 204a.

Alternatively, the browser setting information collection unit 302 may collect and store the browser setting information 206a in the data storage unit 303 when the address of the website 204a is registered as a bookmark in the browser, when the URL is registered in the list box or the like, or each time the access to the website 204a is successful.

The browser setting information collection unit 302 may collect the browser setting information 206b while the device 100 is being connected to the WLAN 202b. At this time, the device 100 has not yet accessed the website 204a through the WLAN 202b. Next, the browser setting information collection unit 302 transmits the browser setting information 206b to the determination unit 304.

The browser setting information collection unit 302 may collect and transmit the browser setting information 206b to the determination unit 304 each time the device 100 is connected to the WLAN 202b. Alternatively, the browser setting information collection unit 302 may collect and transmit the browser setting information 206b to the determination unit 304 each time the user starts the browser by the device 100 or each time the bookmark, the list box, or the like is displayed.

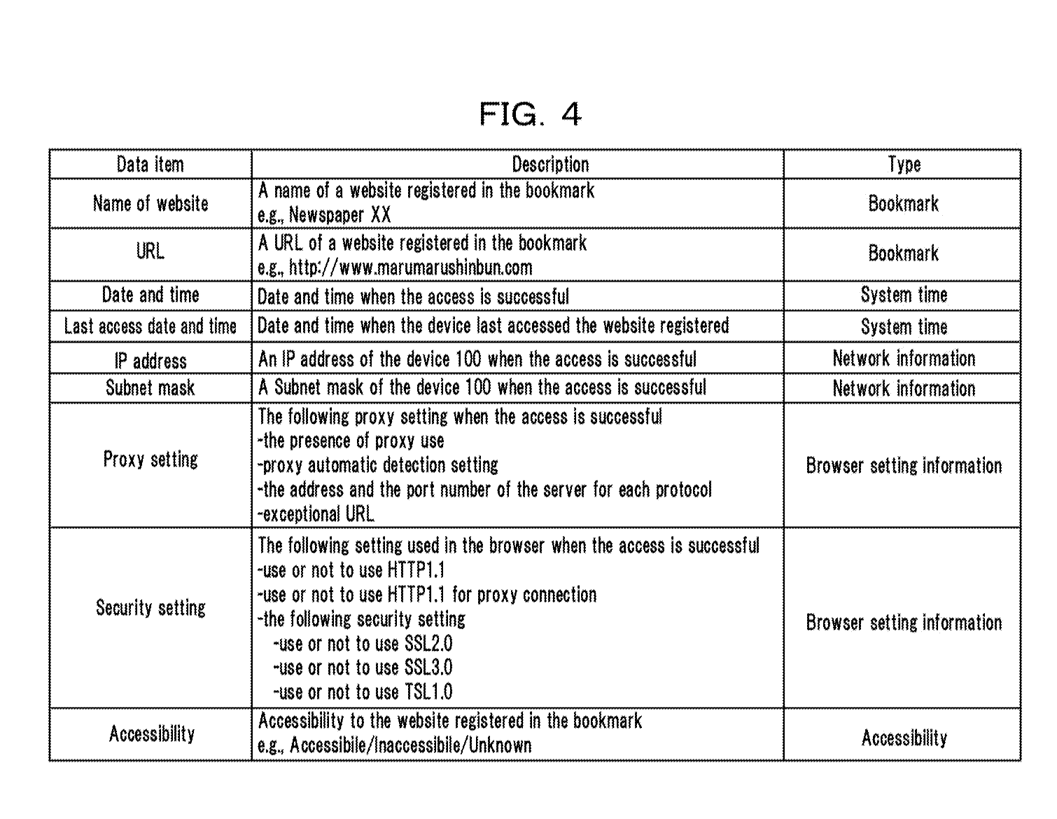

FIG. 4 is an example of data items to be stored in the data storage unit 303 illustrated in FIG. 3. The website name is a name of the websites 204a, 204b, or the like. The URL is a URL of the websites 204a, 204b, or the like and is registered as a bookmark or is registered in the list box or the like. The website and the URL are collected from a bookmark file, which is generated and managed by the browser, by the browser setting information collection unit 302, and are then stored in the data storage unit 303.

Date and time is the date and time when the access to the website 204a is successful. Last access date and time is the date and time when the device 100 last accessed the website registered as a bookmark, for example, the website 204a. The date and time and the last access date and time are based on the system time of the device 100.

The IP address is an IP address that was set in the device 100 when the access to the website 204a was successful. The subnet mask is a subnet mask that was set in the device 100 when the access to the website 204a was successful. The IP address and the subnet mask are collected from the memory 111 by the network information collection unit 301 and are then stored in the data storage unit 303.

The proxy setting is a proxy setting that was set in the device 100 when the access to the website 204a was successful. The proxy setting includes setting whether or not to use a proxy, setting whether or not to automatically detect a proxy, an address, and a port number of the server for each protocol, and information related to a URL for permitting the access in an exceptional case.

The security setting is a setting related to the security that is set in the browser. The security setting includes setting whether or not to use HTTP1.1, setting whether or not to use HTTP1.1 at the time of being connected to a proxy, and setting whether or not to use SSL2.0, SSL3.0, or TSL1.0.

The proxy setting and the security setting are collected from a file, which is generated and managed by the browser, by the browser setting information collection unit 302, and are then stored in the data storage unit 303. The security setting is set in a “Details” tab in, for example, the Internet setting in Windows (R) XP.

The accessibility indicates whether or not the access to the website 204a registered as a bookmark is possible. The accessibility is received from the determination unit 304 as described below.

The data items illustrated in FIG. 4 correspond to the network information 205a and the browser setting information 206a when the access to the website 204a is successful. After being connected to the WLAN 202b, the data storage unit 303 may further include the same data items as in FIG. 4 with respect to the network information 205b and the browser setting information 206b that are collected before the access to the website 204a is performed.

Alternatively, after being connected to the WLAN 202b, each of the data items, which are stored in the data storage unit 303 when the access to the website 204a is successful, may be updated by the network information 205b and the browser setting information 206b that are collected before the access to the website 204a is performed. Furthermore, the data storage unit 303 may store the presence of an update indicating whether or not the respective data items are updated.

Alternatively or additionally, the data storage unit 303 may store the presence of a difference indicating whether or not there is a difference between the network information 205a and 205b and between the browser setting information 206a and 206b for each data item.

Description was made of an example of using a bookmark with reference to FIG. 4. A list box or the like may also be used. When the list box or the like is used, a file for the list box having the same data items as in FIG. 4 may be used instead of a bookmark file.

Description will be made with reference to FIG. 3. The determination unit 304 receives, from the data storage unit 303, the network information 205a, which is collected by the network information collection unit 301 when the access to the website 204a is successful and is then stored in the storage unit 303. Furthermore, after being connected to the WLAN 202b, the determination unit 304 receives, from the network information collection unit 301, the network information 205b collected by the network collection unit 301 before the access to the website 204a is performed.

The determination unit 304 compares the network information 205a and 205b with respect to, for example, the data items illustrated in FIG. 4, and then extracts the difference. Next, the determination unit 304 transmits the extracted difference to the data storage unit 303. For example, if the IP address of the network information 205a is different from the IP address of the network information 205b, the IP address of the network information 205b may be transmitted to the data storage unit 303. Alternatively, the determination unit 304 may update the presence of the update or the presence of the difference stored in the data storage unit 303 in association with the IP address.

The determination unit 304 receives, from the data storage unit 303, the browser setting information 206a that is collected by the browser setting information collection unit 302 when the access to the website 204a is successful, and stored in the data storage unit 303. After being connected to the WLAN 202b, the determination unit 304 receives, from the browser setting information collection unit 302, the browser setting information 206b that is collected by the browser setting information collection unit 302 before the access to the website 204a is performed.

The determination unit 304 compares the browser setting information 206a and 206b with respect to the data items indicated in FIG. 4, for example, and then extracts the difference. The determination unit 304 transmits the extracted difference to the data storage unit 303. For example, if the proxy setting of the browser setting information 206a is different from the proxy setting of the browser setting information 206b, the proxy setting of the browser setting information 206b may be transmitted to the data storage unit 303.

Based on the differences between the network information 205a and 205b and between the browser setting information 206a and 206b, the determination unit 304 determines whether or not the website 204a is accessible before the device 100 attempts to access the website 204a.

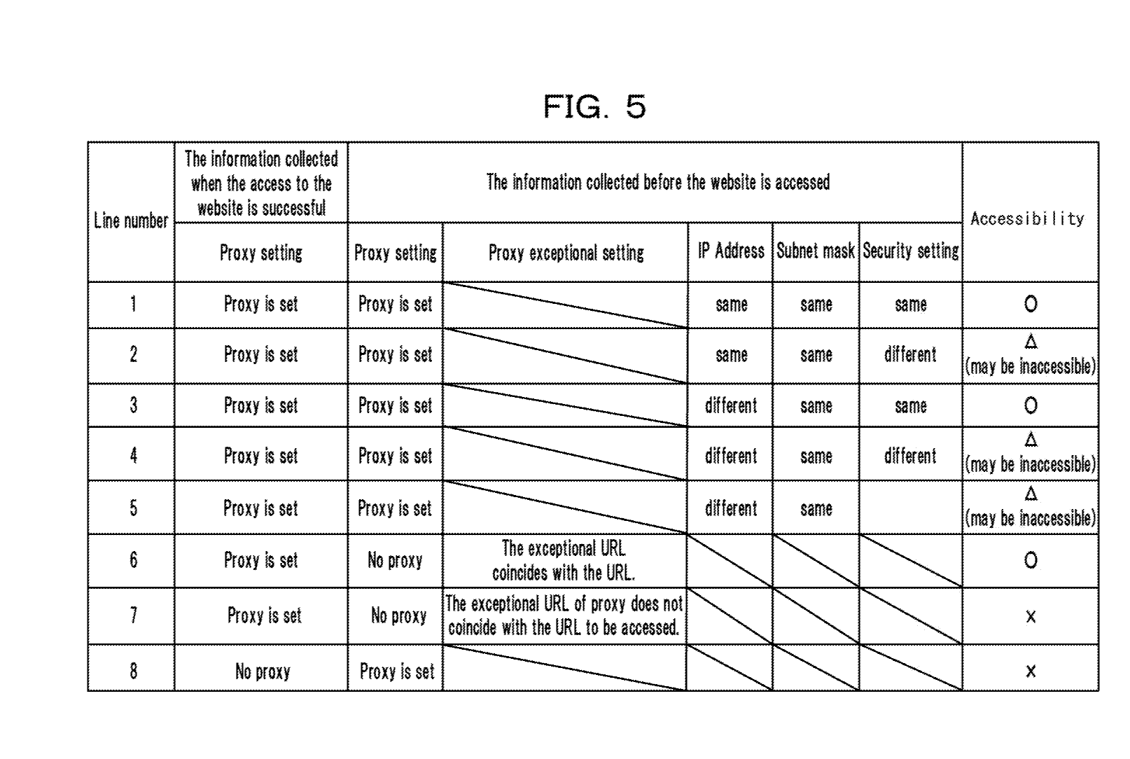

With reference to FIG. 5, description will be made of a case where the determination unit 304 determines the accessibility to the URL registered in the bookmark, the list box, or the like.

In the list in FIG. 5, the row indicated with a line number 1 indicates a case where the IP address included in the network information 205a is the same as the IP address included in the network information 205b. In the row indicated with the line number 1, the proxy setting and the security setting included in the browser setting information 206a are the same as the proxy setting and the security setting included in the browser setting information 206b. In this case, the determination unit 304 determines that the access to a website is possible based on a comparison result. This determination result is indicated as “O” (accessible) in a column of accessibility determination with the line number 1.

The row indicated with a line number 2 indicates a case where the IP addresses, the subnet masks, the proxy settings are the same based on the comparison result by the determination unit 304, but there is a difference in the security settings. In this case, the determination unit 304 determines that the access to the website may be impossible or that it is unknown if the access is possible or not. The determination result is indicated as “Δ” (may be inaccessible) in the column of accessibility determination with the line number 2.

The row indicated with a line number 3 indicates a case where the IP addresses are different, but the subnet masks, the proxy settings, and the security settings are the same. In this case, the determination unit 304 determines that the access to the website is possible. This determination result is indicated as “O” in the column of accessibility determination with the line number 3.

The row indicated with a line number 4 indicates a case where the IP addresses and the security settings are different, but the subnet masks and the proxy settings are the same. In this case, the determination unit 304 determines that the access to the website may be impossible or that it is unknown if the access is possible or not. This determination result is indicated as “Δ” in the column of accessibility determination with the line number 4.

The row indicated with a line number 5 indicates a case where the IP addresses are different, but the subnet masks and the proxy settings are the same. In this case, the determination unit 304 determines that the access to the website may be impossible or that it is unknown if the access is possible or not. This determination result is indicated as “Δ” in the column of accessibility determination with the line number 5.

The rows indicated with a line number 6 and a line number 7 indicate a case where the accessibility is determined based on an exceptional URL in the proxy setting. The exceptional URL is a URL to which connection is not performed through a proxy in an exceptional case.

The URL of the website registered in the bookmark corresponds to the URL stored as the exceptional URL. In this case, the determination unit 304 determines that the access to the website is possible. This determination result is indicated as “O” in the column of accessibility determination with the line number 6.

In the row indicated with a line number 7, the URL of the website registered in the bookmark does not correspond to the URL stored as the exceptional URL. In this case, the determination unit 304 determines that the access to the website is impossible. This determination result is indicated as “X” (inaccessible) in the column of accessibility determination with the line number 7.

The row indicated with a line number 8 indicates a case where the proxy is not set in the information that is collected when the access to the website is successful and where the proxy is set in the information that is collected before the access to the website is performed again. In this case, the determination unit 304 determines that the access to the website is impossible. This determination result is indicated as “X” in the column of accessibility determination with the line number 8.

FIG. 5 illustrates an embodiment in which the accessibility is determined based on some of the data items illustrated in FIG. 4. However, data items in any other combination may also be used to determine the accessibility. In FIG. 5, the determination of accessibility is expressed as three types: Accessible (O), Inaccessible (X), and Unknown or Maybe Inaccessible (Δ). More than three types or less than three types of expressions may be used.

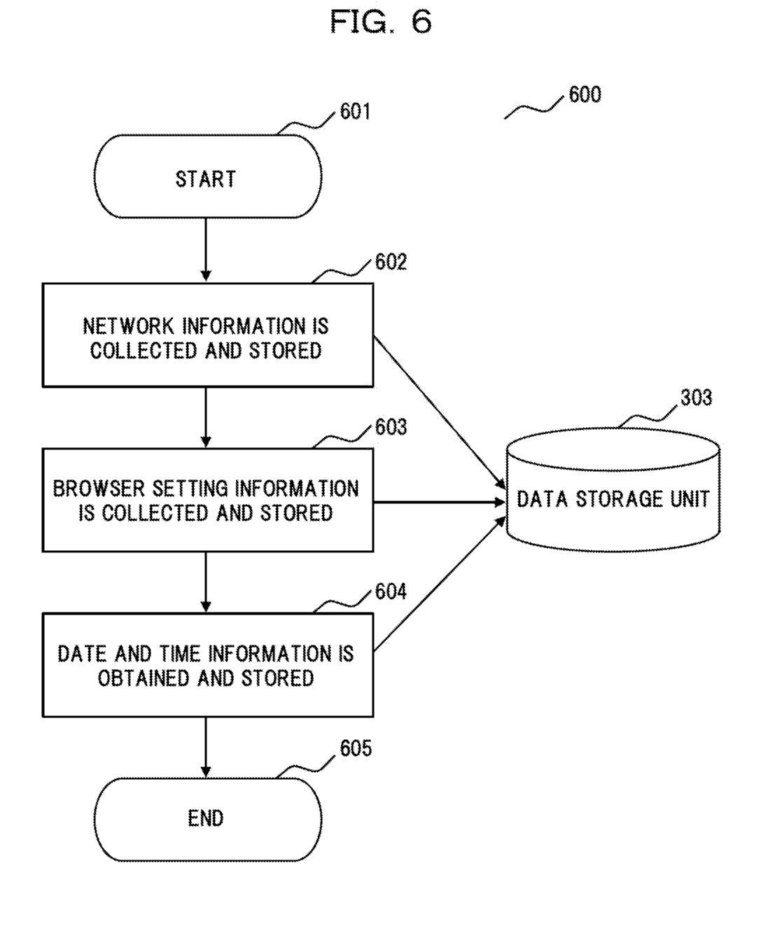

FIG. 6 is a flow diagram of a process 600 for collecting information when the access to the website 204a is successful according to an embodiment. The A-CPU 105 of the device 100 starts the process 600 in Step 601 each time the access to the website 204a, which is registered in the bookmark, the list box, or the like, is successful. The A-CPU 105 may also start the process 600 in Step 601 when the website 204a is registered in the bookmark, the list box, or the like.

In Step 602, the network information collection unit 301 collects the network information 205a that is set in the device 100 and is then stored in the memory 111 or the like. Furthermore, in Step 602, the network information collection unit 301 stores, in the data storage unit 303, the collected network information 205a as the network information 205a in a case where the access to the website 204a is successful. Detailed data items included in the network information 205a were described above with reference to FIG. 4.

In Step 603, the browser setting information collection unit 302 collects the browser setting information 206a that is set in the device 100 from, for example, a file that is generated and managed by the browser and is then stored in the memory 111. In Step 603, the browser setting information collection unit 302 stores, in the data storage unit 303, the collected browser setting information 206a as the browser setting information 206a in a case where the access to the website 204a is successful. The detailed data items included in the browser setting information 206a were described above with reference to FIG. 4.

In Step 604, the data storage unit 303 stores, in the data storage unit 303, the date and time when the network information 205a is stored in the data storage unit 303 in Step 602 and Step 603 as the date and time illustrated in FIG. 4.

In Step 605, the A-CPU 105 ends the process 600.

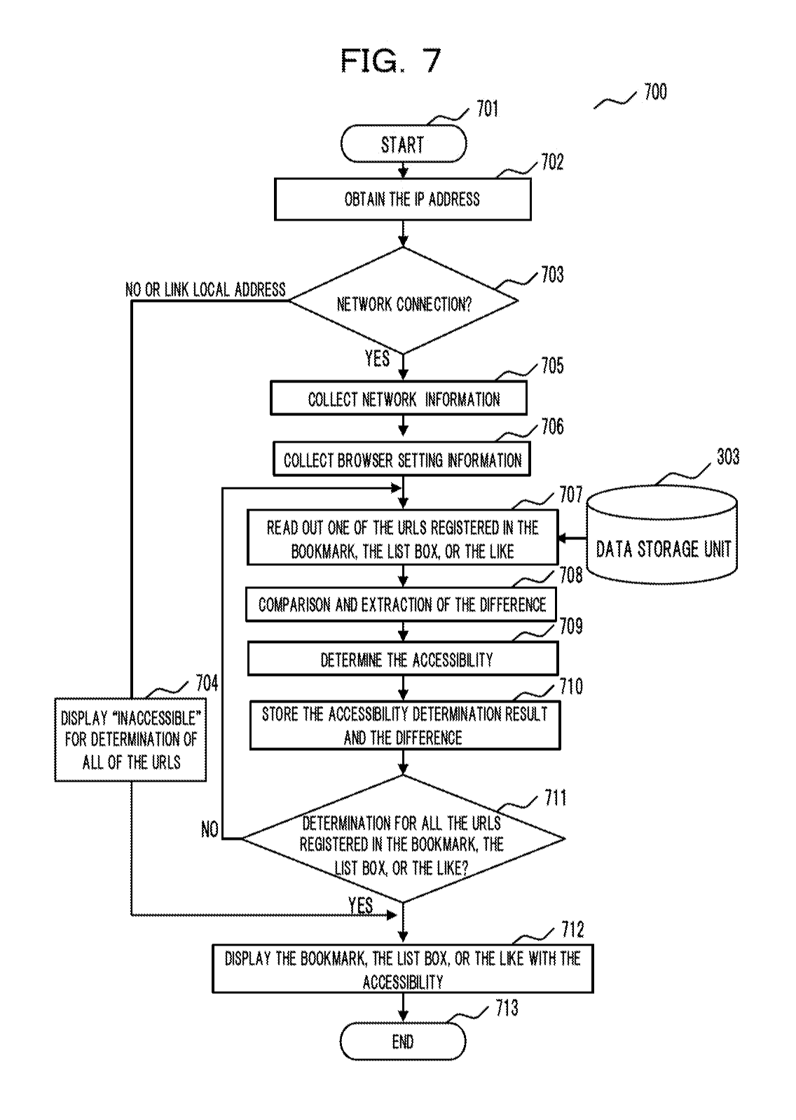

FIG. 7 is a flow diagram of a process 700 for displaying the bookmark, the list box, or the like according to an embodiment. The A-CPU of the device 100 starts the process 700 in Step 701 when the device 100 is connected to the WLAN, when the browser is started, or when the bookmark, the list box, or the like is displayed.

In Step 702, the determination unit 304 obtains the IP address that is set in the device 100 from the memory 111 through the device 100.

In Step 703, the determination unit 304 determines whether or not the device 100 is connected to a network, for example, the WLAN 202a or the WLAN 202b, and whether or not the IP address obtained in Step 702 is a link local address that is used in a range in which communication is not performed through a router. If the device 100 is not connected to the network or if the obtained IP address is a link local address, the process goes to Step 703. When the device 100 is connected to the network, the process goes to Step 704.

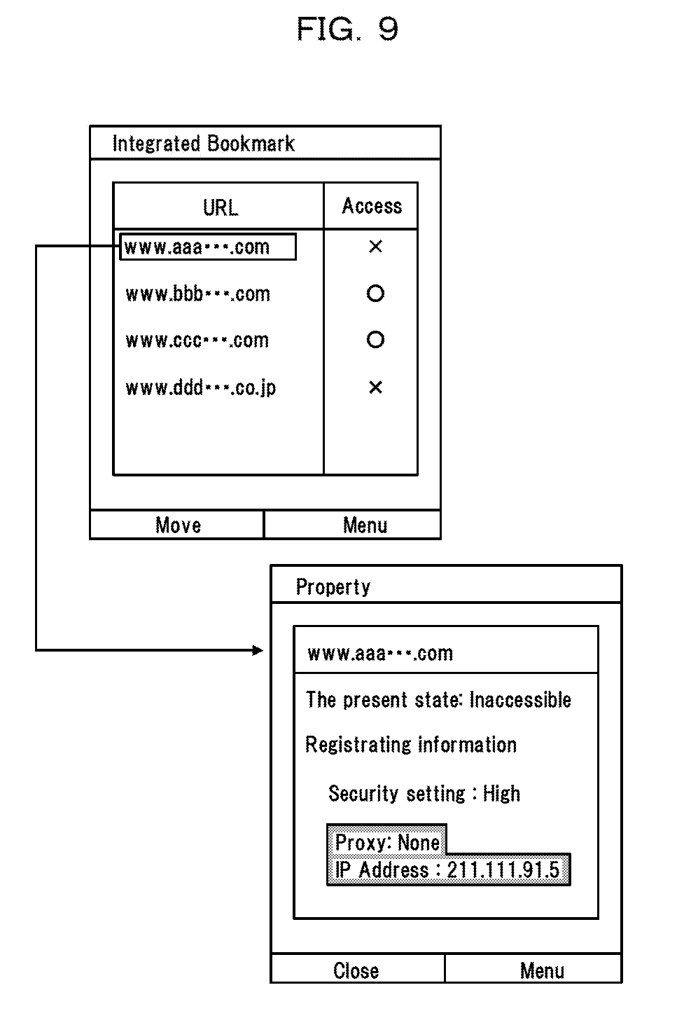

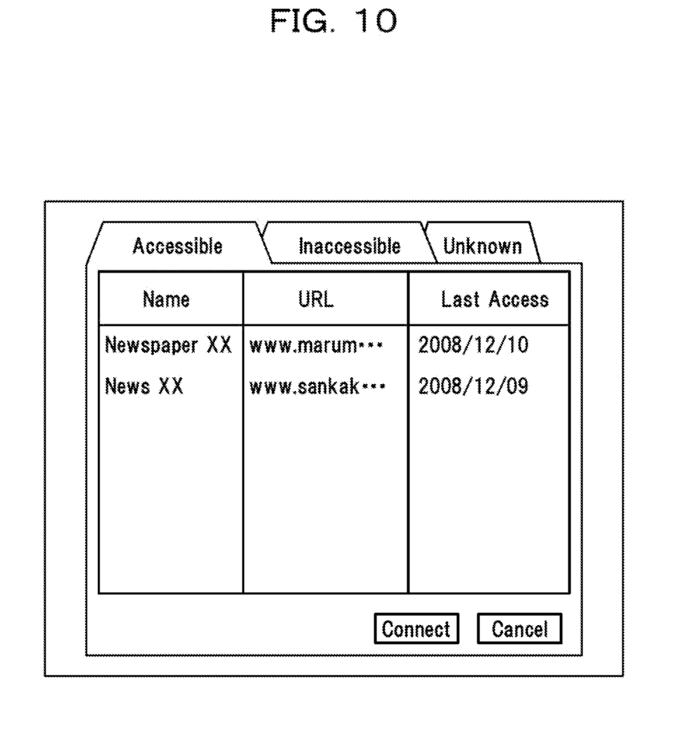

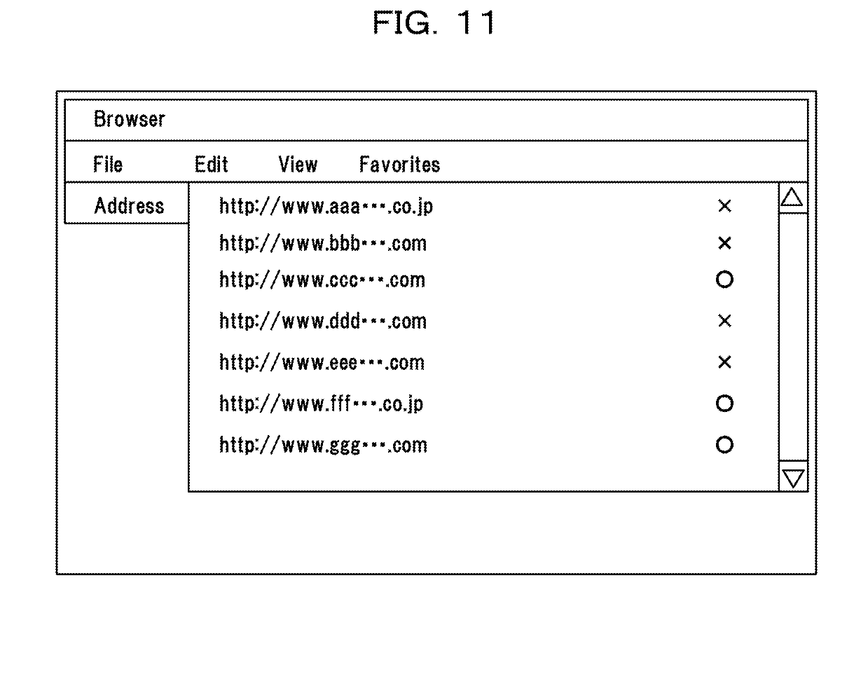

In Step 704, the determination unit 304 determines that all the URLs of the websites registered in the bookmark, the list box, or the like are inaccessible. The determination unit 304 transmits this determination result to the data storage unit 303 or the display unit 305. Furthermore, based on the determination result received from the determination unit 304 and the data items or the same data items illustrated in FIG. 4 read out from the data storage unit 303, the display unit 305 displays the bookmark, the list box, or the like in association with the accessibility. The display examples will be described below with reference to FIG. 9, FIG. 10, and FIG. 11.

In Step 705, after being connected to the WLAN 202b, the network information collection unit 301 obtains, from the memory 111, the network information 205b that is set in the device 100 before the access to the website 204a is performed. The network information collection unit 301 transmits the network information 205b to the determination unit 304.

In Step 706, after being connected to the WLAN 202b, the browser setting information collection unit 302 collects the browser setting information 206b, which is set in the device 100 before the access to the website 204a is performed, from the file that is generated and managed by the browser and is then stored in the memory 111. The browser setting information collection unit 302 transmits the browser setting information 206b to the determination unit 304.

In Step 707, as for one of the URLs registered in the bookmark, the list box, or the like, the determination unit 304 reads out, from the data storage unit 303, the network information 205a and the browser setting information 206a that are stored in Step 602 and Step 603.

In Step 708, the determination unit 304 compares the network information 205a and the browser setting information 206a read out in Step 707 to the network information 205b and the browser setting information 206b collected in Step 705 and Step 706, and then extracts the difference.

In Step 709, based on the difference extracted in Step 708, the determination unit 304 determines whether or not the access to the website, which is registered in the bookmark, the list box, or the like selected in Step 707, is possible. The determination is performed as described above with reference to FIG. 5, for example.

In Step 710, the determination unit 304 stores the determination result obtained in Step 709 and the extracted difference in the data storage unit 303.

In Step 711, the determination unit 304 determines whether or not the processes from Step 707 to Step 710 are performed with respect to all the URLs registered in the bookmark, the list box, or the like. If the processes from Step 707 to Step 710 have already been performed with respect to all the URLs registered in the bookmark, the list box, or the like, the process goes to Step 712. If not, the process goes back to Step 707. Then the processes from Step 707 to Step 710 are performed with respect to the URL registered in another bookmark, another list box, or the like.

In Step 712, the determination unit 304 transmits, to the display unit 305, the determination result from Step 710 with respect to the URL registered in each bookmark, each list box, or the like. Based on the determination result received from the determination unit 304 and the data items illustrated in FIG. 4 read out from the data storage unit 303, the display unit 305 displays the bookmark, the list box, or the like in association with the accessibility. The examples of the display will be described below with reference to FIG. 9 and FIG. 10.

In Step 713, the A-CPU 105 ends the process 700.

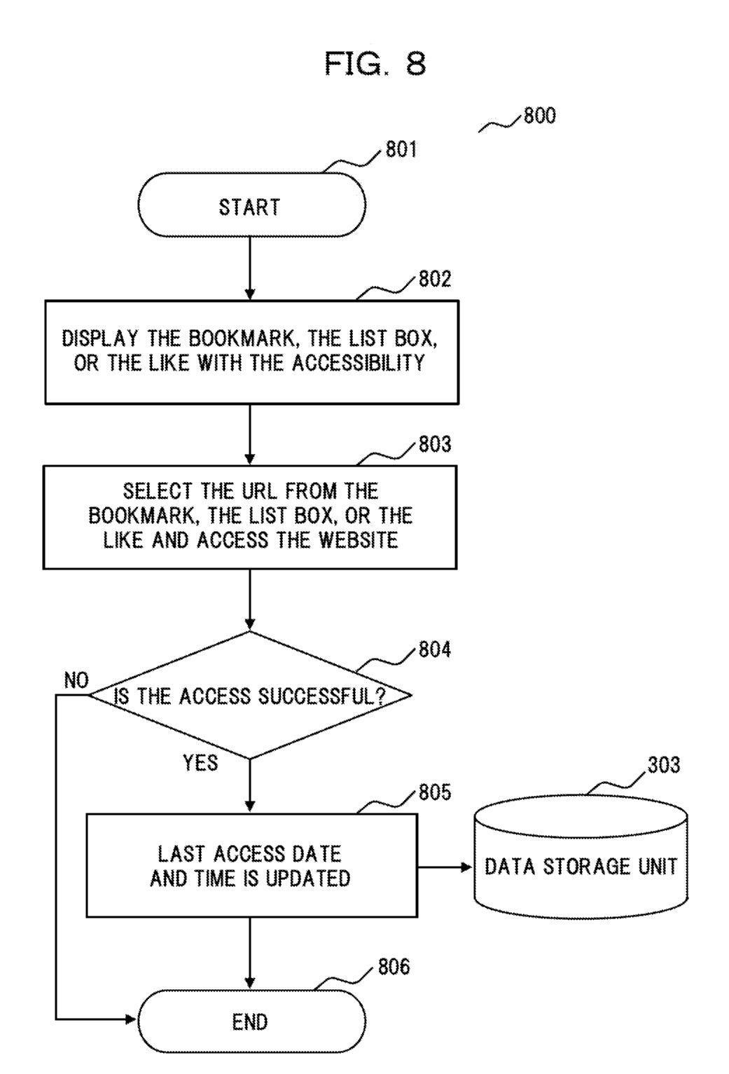

FIG. 8 is a flow diagram of a process 800 for connecting to the URL registered in the bookmark, the list box, or the like according to an embodiment. The A-CPU 105 of the device 100 starts the process 800 in Step 801.

In step 802, based on the determination result received from the determination unit 304 and the data items illustrated in FIG. 4 read out from the data storage unit 303, the display unit 305 displays the bookmark, the list box, or the like in association with the accessibility.

In Step 803, when the user selects the URL of the website registered in the bookmark, the list box, or the like, the device 100 attempts to access the selected website.

In Step 804, the process determines whether or not the access is successful. If the access is successful, the process goes to Step 805. If the access fails, the process goes to Step 806 and the A-CPU 105 ends the process 800.

In Step 805, the access date and time is determined based on system time of the device 100 and is then stored as the last access date and time in the data storage unit 303.

In Step 806, the A-CPU 105 ends the process 800.

FIG. 9 is a display example 900 of accessibility to the bookmark according to an embodiment. FIG. 9 is an example in which the display unit 305 displays a URL and the accessibility to the URL. One of the URLs corresponds to one of the bookmarks and is displayed with the accessibility that is determined in Step 709.

The user may select one of the displayed URLs and request further information to be displayed. Depending on the request, the display unit 305 may read out, from the data storage unit 303, and display the network information, the browser setting information, the accessibility, and the like corresponding to the selected URL.

In the example illustrated in FIG. 9, a property as detail information of the URL displays the present accessibility, the security setting, the proxy setting, and the IP address that are collected when the access to the website is successful. The security setting may be displayed as, for example, High, Middle, or Low depending on the content of the security setting illustrated in FIG. 4.

The proxy and the IP address are highlighted and displayed because the content that is collected when the access to the website is successful is different from the content that is collected before the access to the website is performed after the device 100 is connected to the network. By checking the highlighted items, the user may find a reason why the selected website is inaccessible and may solve this problem.

Alternatively, as the detail information of the URL, after the device 100 is connected to the network, the information collected before the user accesses the website may be displayed. In this case, a part that is different from the content collected when the access to the website is successful may be highlighted and displayed.

FIG. 10 is another display example of accessibility to the bookmark according to an embodiment. FIG. 10 displays a website that is determined to be accessible, a website that is determined to be inaccessible, and a website that is determined to be unknown if the access is possible or not.

As in FIG. 9, the user may select one of the URLs displayed in each tab and request further information to be displayed. In response to the request, the display unit 305 may read out the network information corresponding to the selected URL, the browser setting information, the accessibility, and the like from the data storage unit 303. The data item whose content is changed is highlighted and displayed to provide the user with a hint to solve the problem. The data item whose content is changed is highlighted and displayed to provide the user with a hint to solve the problem. Alternatively, only the changed data item may be displayed.

FIG. 11 is a display example of accessibility to the URL registered in the list box or the like according to an embodiment. In FIG. 11, when the list box is displayed from a pull-down list in the address bar, each of the URLs is displayed in the list with a sign such as “O” and “X” indicating the accessibility. Instead of the sign such as “O” and “X,” “Accessible,” “Inaccessible,” or pictures corresponding to the signs may be displayed.

The above-described embodiment describes a case where the access to the website 204a is performed before or after the WLAN to which the device 100 is connected is changed from the WLAN 202a into the WLAN 202b. In another embodiment, while the device 100 is staying in the same WLAN service area, the above-described method may be performed each time the device 100 is connected to the WLAN, and each time when the browser is started regularly while the device 100 is being connected to the WLAN, or each time the bookmark is displayed.

The above-described embodiment describes an example in which the device 100 accesses the website 204a from the WLAN 202a through the proxy 203 and the Internet 201. In another embodiment, the device 100 may access the website 204b stored in the WLAN 202a instead of the website 204a without through the proxy.

The above-described embodiment describes a case where the device 100 is a mobile device. In another embodiment, the device 100 may be a desktop-style personal computer.

According to the above-described embodiment, it is possible to reduce the time required to confirm whether or not the website is accessible.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A device that is connectable to a network, the device comprising:
a storage unit that stores first setting information related to a accessible website in association with an identifier of the website, and
a determination unit that determines whether or not the website is accessible by comparing the first setting information to second setting information that is set in the device before access to the website is performed while the device is connected to the network.

2. The device according to claim 1, further comprising a display unit which displays a result of the determination together with an identifier of the website.

3. The device according to claim 2, wherein the display unit displays an item of the first setting information which is different from the item of the second setting information, when the first setting information is different from the second setting information.

4. A method used in a device which is connectable to a network, wherein the method comprises:
storing first setting information related to a accessible website in association with an identifier of the website, and
determining whether or not the website is accessible by comparing the first setting information to second setting information which is set in the device before access to the website is performed while the device is connected to the network.
